(19) United States
(12) Patent Application Publication
(10) Pub. No.: US 2026/0228013 A1
(43) Pub. Date: Aug. 6, 2026

(54) SPLIT FIRMWARE ARCHITECTURE

(71) Applicant: Micron Technology, Inc., Boise, ID (US)

(72) Inventor: Marco REDAELLI, Munich (DE)

(21) Appl. No.: 19/413,687

(22) Filed: Dec. 9, 2025

Related U.S. Application Data
(60) Provisional application No. 63/755,082, filed on Feb. 6, 2025.

(51) Int. Cl. G06F 9/4401

(52) U.S. Cl. CPC G06F 9/4401

(57) ABSTRACT

Implementations described herein relate generally to a split firmware architecture. For example, a memory system may store, in a first firmware slot at a memory system, a first firmware image associated with an operational mode of the memory system. The memory system may store, in a second firmware slot at the memory system, a second firmware image associated with a diagnostic mode of the memory system. The memory system may activate either the first firmware slot or the second firmware slot based at least in part on operating the memory system in the operational mode or in the diagnostic mode.

### CROSS REFERENCE TO RELATED APPLICATION

This Patent Application claims priority to U.S. Provisional Patent Application No. 63/755,082, filed on February 6, 2025, and entitled “STORING DATA TO HOST SYSTEM MEMORY UPON ENTRY OF A MEMORY SYSTEM NON-OPERATIONAL POWER STATE.” The disclosure of the prior Application is considered part of and is incorporated by reference into this Patent Application.

### TECHNICAL FIELD

The present disclosure generally relates to memory devices, memory device operations, and, for example, to split firmware architecture.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

These memory devices may be organized within a memory system, which coordinates the reading, writing, and management of data across multiple memory devices to improve overall performance and reliability. The memory system may integrate various types of memory devices to form a cohesive unit capable of efficient data storage and retrieval. The memory system may rely on firmware to manage an operation of the memory system. Firmware may control and/or manage operations of one or more hardware components within the memory system. Firmware may be stored in non-volatile memory, such as read-only memory (ROM) or flash memory. Functions such as initializing hardware, managing device resources, and/or facilitating communication between hardware and software, among other examples, may be carried out by and/or controlled via firmware.

### BRIEF DESCRIPTION OF THE DRAWINGS

FIGS. 1 and 2 are diagrams illustrating example systems that support a split firmware architecture.

FIGS. 3 and 4 are examples of processes that are performed by a memory system that supports a split firmware architecture.

FIG. 5 is a flowchart of an example method associated with a memory system that includes a split firmware architecture.

### DETAILED DESCRIPTION

Some memory systems may be configured with both an operational functionality (e.g., associated with the memory system being in an operational mode) and an offline functionality (e.g., associated with the memory system being in an offline mode). The operational functionality of the memory system may be associated with the memory system executing commands received from a host system. The operational functionality of the memory system may correspond to a core functionality of the memory system. The offline functionality of the memory system may be associated with the memory system refraining from executing commands received from the host system. In some cases, the offline functionality of the memory system may include diagnostic or self-test functionalities of the memory system. That is, the memory system may be configured to perform one or more operations, in the offline mode, that improve the reliability of the memory system. For example, the memory system may perform self-test operations (e.g., associated with device field self-test procedures), wear leveling procedures, error correction or scrubbing operations, or garbage collection operations while the memory system is in an offline mode (e.g., while the memory system is not receiving or executing commands from the host system).

Some memory systems may include monolithic firmware that includes both the operational and offline functionalities of the memory system. This integration (e.g., of both the operational functionality and the offline functionality of the memory system within the monolithic firmware) poses a challenge, as any modification to the offline functionality of the memory system necessitates a firmware update in the field (an update to the firmware that occurs after the memory system is coupled to a host system and powered on). For example, to update a self-test functionality of the memory system, the memory system may have to perform a firmware update on the monolithic firmware of the memory system, which may also have ramifications on other functionalities of the memory system (such as on the core functionality of the memory system). Firmware updates in the field may be disruptive and may include extensive revalidation prior to deployment, a process that may be both time-consuming and costly, especially if the memory system is deployed in an environment associated with stringent quality control (e.g., within an automotive application). The single monolithic firmware that corresponds to both the operational and offline functionality of the memory system may limit the ability for both a customization of the firmware and a rapid deployment of updates to the firmware based on evolving customer needs or technological advancements.

Some implementations described herein provide a memory system with a split firmware architecture that allows for independent management of the operational functionality of the memory system and the offline functionality of the memory system. In particular, instead of storing a single firmware image that corresponds to the monolithic firmware of the memory system, the memory system may store a first firmware image that corresponds to a first subset of the firmware in a first firmware slot and a second firmware image that corresponds to a second subset of the firmware (e.g., that is disjoint from the first subset) in a second firmware slot. For example, the memory system may include a first firmware slot to store a first firmware image associated with the operational functionality of the memory system (e.g., including the operational functionality of the memory system), and a second firmware slot to store a second firmware image associated with an offline functionality of the memory system (e.g., including a diagnostic functionality and/or a self-test functionality of the memory system).

The memory system may activate one of the firmware slots and deactivate or disable the other, such that the memory system may operate according to the first firmware image associated with the operational functionality of the memory system or according to the second firmware image associated with the offline functionality of the memory system. This means that when the memory system activates the second firmware slot, the memory system operates in an offline mode, and when the memory system activates the first firmware slot, the memory system operates in the normal operational mode. The memory system may switch between these modes based on commands from a host system (e.g., indicating for the memory system to activate the first or second firmware slot).

In some aspects, splitting the monolithic firmware into subsets may enable the memory system to update the firmware image in one slot (e.g., corresponding to a first subset of the firmware) independently of the firmware image stored in the other slot (e.g., corresponding to a second subset of the firmware). For example, the memory system may update the firmware image associated with the offline functionality of the memory system without impacting the core functionality of the memory system. In this way, the split firmware architecture enables the memory system to separately update and manage the offline firmware without impacting core memory system operations.

This split firmware architecture may reduce the risk of operational disruptions during firmware updates and decrease memory system downtime. That is, by allowing for independent updates of the offline firmware, the memory system may maintain high levels of reliability and performance, as updates to the offline firmware may be deployed without affecting the primary operation of the memory system. Furthermore, the ability of the memory system to independently update the offline firmware may conserve processing and memory resources, as the firmware update may be more targeted and smaller in scale, thus using less memory and processing power to implement. This split firmware architecture may also reduce comprehensive revalidation of the entire firmware prior to implementing firmware updates (e.g., prior to implementing offline firmware updates), which may in turn reduce the labor and computational resources previously used for firmware validation procedures.

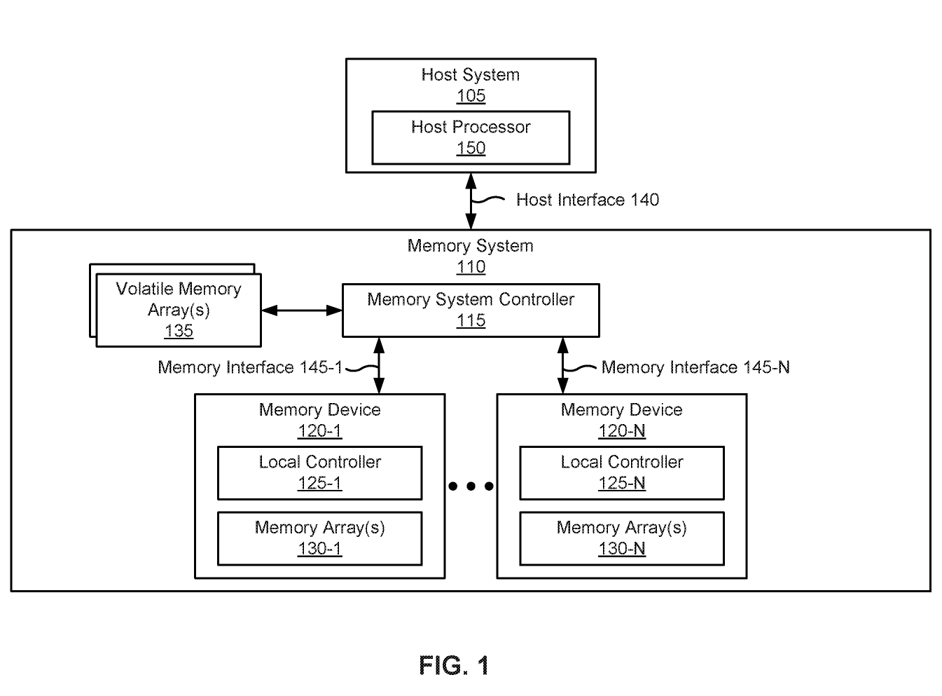

FIG. 1 is a diagram illustrating an example system 100 that supports a split firmware architecture. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

In some cases, the memory system 110 may be a managed non-volatile memory (mNVM) system. That is, the memory system 110 may include one or more non-volatile memory components (e.g., the memory device 120-1 and/or the memory device 120-N may correspond to non-volatile memory devices). Further, if the memory system 110 is an mNVM system, the memory system controller 115, and firmware stored at the memory system 110, may perform one or more operations to improve the reliability of data stored by the memory system 110. For example, the memory system 110 may perform wear leveling operations, garbage collection operations, error correction operations, or other types of operations that improve the reliability or performance of the memory system 110. In some examples, an mNVM system may include a managed NAND device or a managed SSD.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115 and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some examples, the memory system 110 may be configured with both an operational functionality (e.g., associated with the memory system 110 being in an operational mode) and an offline functionality (e.g., associated with the memory system 110 being in an offline mode). The operational functionality of the memory system 110 may be associated with the memory system 110 executing commands received from a host system 105. The operational functionality of the memory system 110 may correspond to a core functionality of the memory system 110. The offline functionality of the memory system 110 may be associated with the memory system 110 refraining from executing commands received from the host system 105. That is, while in the offline mode, the memory system 110 may not be receiving commands from the host system 105 (for example, the memory system 110 may not communicate with the host system 105 via the host interface 140) and may instead be performing internal operations. In some cases, the offline functionality of the memory system 110 may include diagnostic or self-test functionalities. For example, the memory system 110 may perform self-test operations (e.g., associated with device field self-test procedures), wear leveling procedures, error correction or scrubbing operations, or garbage collection operations while the memory system 110 is in an offline mode. In one example of an offline functionality of the memory system 110, the memory system 110 may incorporate built-in monitoring mechanisms, such as the Self-Monitoring, Analysis, and Reporting Technology (S.M.A.R.T.), to conduct diagnostic tests and provide an indication of the health of the memory system 110. For example, the memory system 110 may correspond to a managed NAND memory system, an SSD, or a hard disk drive, and the memory system 110 may include a built-in monitoring system such as the device field self-test.

Some memory systems 110 may include monolithic firmware that corresponds to both the operational and offline functionalities of the memory system 110. This integration (e.g., of both the operational functionality and the offline functionality of the memory system 110 within the firmware) poses a challenge, as any modification to the offline functionality of the memory system 110 necessitates a firmware update in the field (an update to the firmware that occurs after the memory system 110 is coupled to the host system 105 and powered on). For example, to update a self-test functionality of the memory system 110, the memory system 110 may perform a firmware update on the monolithic firmware of the memory system 110, which may also have ramifications on other functionalities of the memory system 110 (such as on the core functionality of the memory system 110). In an example where the memory system 110 is deployed within an automotive context, a firmware update in the field may correspond to an over-the-air firmware update or a firmware update that is installed at a location that specializes in automative firmware updates (e.g., an automotive service center, an automotive repair shop).

Firmware updates in the field may be disruptive and may include extensive revalidation prior to deployment, a process that may be both time-consuming and costly, especially if the memory system is deployed in an environment associated with stringent quality control (e.g., within an automotive application). That is, because updating the firmware of the memory system 110 may potentially impact the core functionality (such as the operational functionality) of the memory system 110, the firmware update may be tested extensively prior to deploying the firmware update in the memory system 110.

For example, prior to deploying a firmware update to a memory system 110 within an automotive context, a new product change request may be submitted and a revalidation of the proposed updated firmware may be performed (e.g., by a quality and/or reliability department). Because such firmware updates are both time-consuming and costly, a customization of the firmware and a rapid deployment of updates to the firmware based on evolving customer needs may be limited.

Some implementations described herein provide a memory system 110 with a split firmware architecture that allows for independent management of the operational functionality of the memory system 110 and the offline functionality of the memory system 110. In particular, instead of storing a single firmware image that corresponds to the entire firmware of the memory system 110, the memory system 110 may store a first firmware image that corresponds to a first subset of the firmware in a first firmware slot and a second firmware image that corresponds to a second subset of the firmware (e.g., that is disjoint from the first subset) in a second firmware slot. For example, the memory system 110 may include a first firmware slot to store a first firmware image associated with the operational functionality of the memory system 110 (e.g., including the operational functionality of the memory system 110), and a second firmware slot to store a second firmware image associated with an offline functionality of the memory system 110 (e.g., including a diagnostic functionality and/or a self-test functionality of the memory system 110).

In some implementations, the memory system 110 may include a memory array (such as a memory array 130) comprising: a first firmware slot configured to store a first firmware image associated with a first disjoint subset of a firmware for the memory system 110, and a second firmware slot configured to store a second firmware image associated with a second disjoint subset of the firmware for the memory system 110; and a controller (such as the memory system controller 115) coupled to the memory array, the controller configured to: operate the memory system 110 according to the first disjoint subset of the firmware based at least in part on activating the first firmware slot and deactivating the second firmware slot, or operate the memory system 110 according to the second disjoint subset of the firmware based at least in part on deactivating the first firmware slot and activating the second firmware slot.

In some implementations, one or more systems, devices, apparatuses, components, and/or controllers of FIG. 1 may be configured to store, in a first firmware slot at a memory system, a first firmware image associated with an operational mode of the memory system; store, in a second firmware slot at the memory system, a second firmware image associated with a diagnostic mode of the memory system; and activate either the first firmware slot or the second firmware slot based at least in part on operating the memory system in the operational mode or in the diagnostic mode.

In some implementations, one or more systems, devices, apparatuses, components, and/or controllers of FIG. 1 may be configured to store, in a first firmware slot at the memory device, a first firmware image associated with an operational mode of the memory device; store, in a second firmware slot at the memory device, a second firmware image associated with a diagnostic mode of the memory device; and activate either the first firmware slot or the second firmware slot based at least in part on operating the memory device in the operational mode or in the diagnostic mode.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

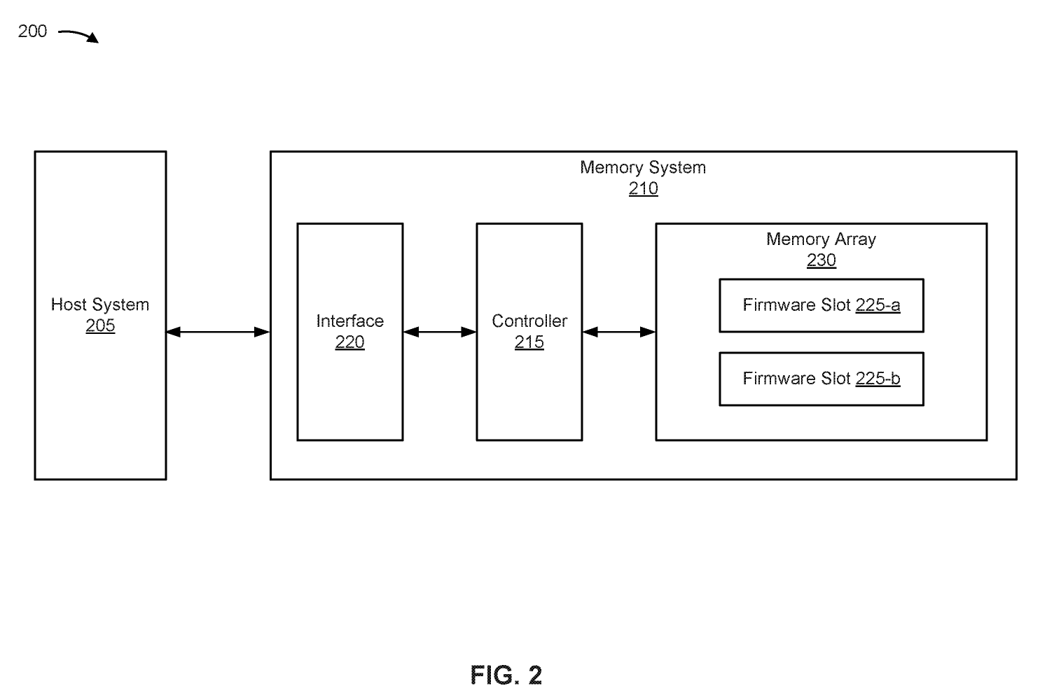

FIG. 2 is a diagram illustrating an example of a system 200 that supports a split firmware architecture. The system 200 may include a host system 205 and the memory system 210, which may be examples of the host system 105 and the memory system 110, respectively. The memory system 210 may include an interface 220, a controller 215, and a memory array 230. In some cases, the interface 220 may be an example or include aspects of the host interface 140, the controller 215 may be an example or include aspects of the memory system controller 115 or the local controllers 125, and the memory array 230 may be an example or include aspects of the memory arrays 130.

The memory array 230 may be a non-volatile memory array. While the system 200 illustrates the memory array 230 being coupled to the controller 215, in some other examples, the controller 215 may include the memory array 230. The memory array 230 may include distinct partitions that correspond to different firmware slots 225. Each partition of the memory array 230 (e.g., each firmware slot 225) may correspond to a division of the memory array 230 into distinct segments or blocks that are each used to store a different firmware image. A firmware slot 225 may correspond to a location within the memory array 230 (which may, in some examples, be within the controller 215) that is used to store a firmware image. Firmware images may be specific versions of firmware that are stored within the firmware slots 225 and that the controller 215 may load and execute. While the example system 200 illustrates the memory array 230 including two firmware slots 225: the firmware slot 225-a and the firmware slot 225-b, but in other examples, a memory system 210 (such as within a memory array 230 that may be included in the controller 215) may include more firmware slots 225 (e.g., may include five firmware slots 225 or ten firmware slots 225).

In the system 200, the two firmware slots 225-a and 225-b may each store a subset of the firmware of the memory system 210. That is, the firmware for the memory system 210 may be divided into two or more subsets (e.g., that are disjoint, that are non-overlapping, that each correspond to a distinct functionality of the memory system 210) and stored in different firmware slots 225. For example, the firmware of the memory system 210 may be divided into a first subset and a second subset, where the first subset of the firmware corresponds to a core functionality of the memory system 210 and the second subset of the firmware corresponds to an offline or diagnostic functionality of the memory system 210. Then, the memory system 210 may store the firmware images corresponding to each subset of the firmware in different firmware slots 225 of the memory system 210. In the system 200, the memory system 210 may store the subset of the firmware corresponding to the core functionality of the memory system 210 in the firmware slot 225-a and may store the subset of the firmware corresponding to the offline or diagnostic functionality of the memory system 210 in the firmware slot 225-b.

The subset of the firmware that corresponds to the core functionality of the memory system 210 may be referred to as the core firmware or the operational firmware of the memory system 210. This subset of the firmware may enable the memory system 210 to operate in an operational mode, where the memory system 210 is receiving and executing commands from the host system 205. That is, while operating according to this subset of the firmware (e.g., the core firmware, the operational firmware), the memory system 210 may be communicating with the host system 205 via the interface 220. In some cases, the memory system 210 operating according to the core firmware may be referred to as the memory system 210 operating in an operational mode or an online mode.

Additionally, the subset of the firmware that corresponds to the offline or diagnostic functionality of the memory system 210 may be referred to as the offline or diagnostic firmware of the memory system 210. This subset of the firmware may enable the memory system 210 to operate in an offline mode, where the memory system 210 is not communicating with the host system 205 via the interface 220. In some examples, the memory system 210 may operate in the offline mode to perform one or more diagnostic operations. Accordingly, the offline mode may also be referred to as a diagnostic or self-test mode.

In one example, the first subset of the firmware may provide all of the functionality of the memory system 210 (e.g., all of the functionality of an mNVM) other than one or more offline functionalities of the memory system 210. For example, the first subset of the firmware (such as the firmware corresponding to the firmware image that is stored in the firmware slot 225-a) may provide all of the functionality for the memory system 210 other than a diagnostic capability (e.g., a device field self-test functionality such as a S.M.A.R.T. self-test). Additionally, the second subset of the firmware may provide the diagnostic functionality to the memory system 210 (the device field self-test functionality including the S.M.A.R.T. self-test).

The memory system 210 may only activate a single firmware slot 225 at once. Based on dividing the firmware of the memory system 210 into the core or operational firmware and the diagnostic or offline firmware and the memory system 210 only activating the single firmware slot 225 at a time, the memory system 210 may be operating either in the operational mode (e.g., based on the controller 215 executing the core or operational firmware stored in the firmware slot 225-a) or in the offline mode (e.g., based on the controller 215 executing the diagnostic or offline firmware stored in the firmware slot 225-b). That is, the memory system 210 may select a firmware slot 225 (e.g., a single firmware slot 225) to activate and may activate the corresponding firmware slot 225 by loading and initiating the firmware image stored in that firmware slot 225. For example, the controller 215 may execute either the firmware image stored in the firmware slot 225-a or the firmware image stored in the firmware slot 225-b. Additionally, the controller 215 may deactivate the one or more firmware slots 225 that are not selected to be activated.

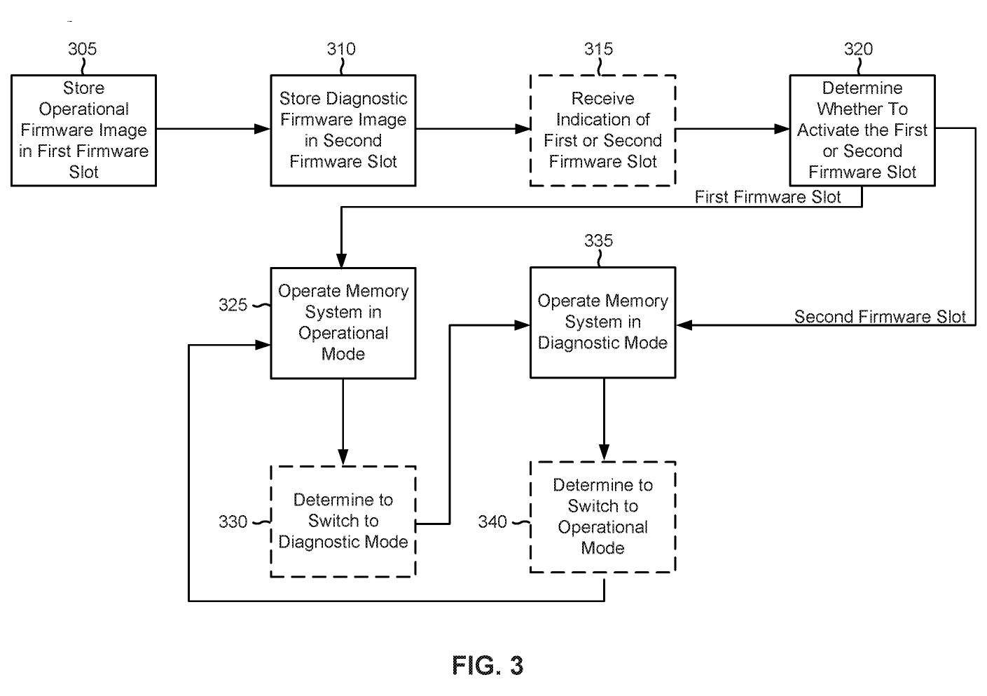

An example process of the memory system 210 operating in either the operational mode or the diagnostic mode is described with reference to FIG. 3.

By dividing the firmware of the memory system 210 into distinct subsets and storing firmware images corresponding to each subset of the firmware separately (e.g., within different firmware slots 225), the memory system 210 may be capable of updating a subset of the firmware (e.g., that corresponds to one firmware image stored in one of the firmware slots 225) without impacting the other subset of the firmware (e.g., that corresponds to a different firmware image stored in a different one of the firmware slots 225). In some cases, this may enable the memory system 210 to more easily perform updates to the diagnostic or offline firmware. That is, the costly and time-consuming process associated with firmware updates that occur in the field may be associated with firmware updates that may potentially impact the core functionality of the memory system 110. By isolating firmware updates to only impact non-essential functionalities (e.g., functionalities of the memory system 110 that do not impact the operating mode of the memory system 110), the process for performing the diagnostic or offline firmware updates may be more streamlined. For example, firmware updates to the diagnostic or offline firmware may be associated with less testing as compared to firmware updates to the core or operational firmware (e.g., due to not needing to perform a revalidation of the firmware prior to deployment) and without submitting a new product change request.

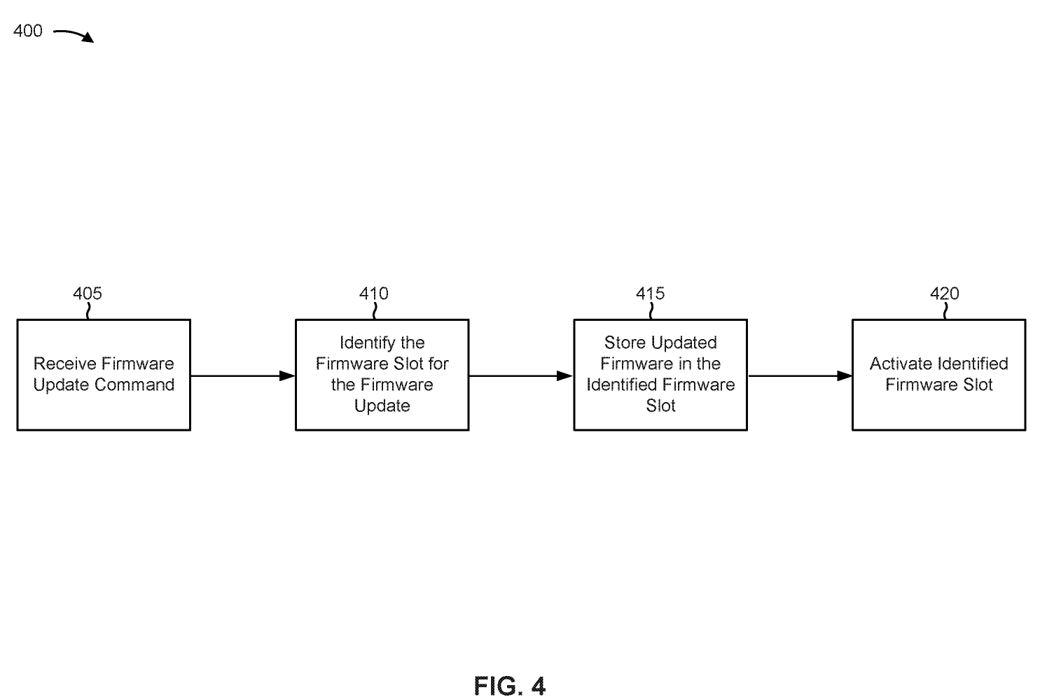

An example process of the memory system 210 updating a subset of the firmware of the memory system 210 (and not impacting the operation of another subset of the firmware) is described with reference to FIG. 4. In some cases, streamlining the updates to the diagnostic or offline firmware may enable improved customization of the self-test testing flow. For example, a deployment scenario of a memory system 210 may impact a desired output of a self-test and/or the diagnostics performed by a self-test. That is, the diagnostics required for a memory system 210 that is deployed within an automotive context may be different from the diagnostics required for a memory system 210 that is deployed within a different context. The split firmware architecture of the memory system 210 may improve a process for customizing the diagnostic firmware of the memory system 210.

As indicated above, FIG. 2 is provided as an example. Other examples may differ from what is described with regard to FIG. 2.

FIG. 3 is a diagram of an example 300 of a process performed by a memory system that supports a split firmware architecture. The operations described in connection with FIG. 3 may be performed by the memory system 210, and/or one the controller 215 or the memory system 210. The example 300 relates to a process of the memory system 210 activating a single firmware slot 225 to operate the memory system 210 in either the operational mode (e.g., the operational or the core functionality mode) or the diagnostic mode (e.g., the diagnostic mode or the offline mode).

At 305, the memory system 210 may store the operational firmware image in a first firmware slot (such as in the firmware slot 225-a). As described above, the operational firmware image may also be referred to as a core firmware image. In some cases, storing the operational firmware image may include the memory system 210 receiving the operational firmware image from the host system 205 via the interface 220. For example, the host system 205 may send a write command to the memory system 210, and the write command may include the operational firmware image and an indication of a destination for the operational firmware image (e.g., an indication of the first firmware slot 225-a). Then, the controller 215 may execute the write operation to store the operational firmware image in the first firmware slot 225-a of the memory array 230 in accordance with the write command.

At 310, the memory system 210 may store the diagnostic firmware image in a second firmware slot (such as in the firmware slot 225-b). As described above, the diagnostic firmware image may also be referred to as an offline firmware image. In some cases, storing the diagnostic firmware image may include the memory system 210 receiving the diagnostic firmware image from the host system 205 via the interface 220. For example, the host system 205 may send a write command to the memory system 210, and the write command may include the diagnostic firmware image and an indication of a destination for the diagnostic firmware image (e.g., an indication of the second firmware slot 225-b). Then, the controller 215 may execute the write operation to store the diagnostic firmware image in the second firmware slot 225-b of the memory array 230 in accordance with the write command.

At 315, the memory system 210 may optionally receive an indication to activate either the first firmware slot 225-a or the second firmware slot 225-b. For example, the host system 205 may send, and the memory system 210 may receive, a command indicating a firmware slot for the memory system 210 to activate. That is, the host system 205 may indicate for the memory system 210 to activate either the first firmware slot 225-a or the second firmware slot 225-b. Accordingly, the host system 205 may optionally command the memory system 210 to operate the memory system 210 in the operational mode (e.g., based on the command indicating the first firmware slot 225-a) or to operate the memory system 210 in the diagnostic mode (e.g., based on the command indicating the second firmware slot 225-b).

At 320, the memory system 210 may determine whether to activate the first firmware slot 225-a or the second firmware slot 225-b. If the memory system 210 receives the command from the host system 205 at 315, the memory system 210 may determine to activate the firmware slot 225 indicated within the command.

Additionally, if memory system 210 does not receive the command from the host system 205 at 315, the memory system 210 may determine whether to activate the first firmware slot 225-a or the second firmware slot 225-b based on a mode of operation associated with the first firmware slot 225-a (e.g., the operational mode) and the second firmware slot 225-b (e.g., the diagnostic mode). For example, the memory system 210 may determine a mode of operation for the memory system 210 based on a startup default mode of operation (e.g., a default mode of operation of the memory system 210 upon an initial power-up of the memory system), a schedule indicative of the mode of operation of the memory system 210 (e.g., the memory system 210 may be configured to periodically switch between the operational mode and the offline or diagnostic mode for maintenance tasks such as wear leveling, garbage collection, or diagnostics such as a S.M.A.R.T. self-test), or an internal trigger to switch to a certain mode of operation (e.g., the memory system 210 may be configured to operate in the offline or diagnostic mode in response to detecting certain conditions within the memory system 210). If the memory system 210 determines to operate in the operational mode, the memory system 210 may determine to activate the first firmware slot 225-a. Additionally, if the memory system 210 determines to operate in the diagnostic mode, the memory system 210 may determine to activate the second firmware slot 225-b.

If at 320 the memory system 210 determines to activate the first firmware slot 225-a, the memory system 210 may proceed to 325. Additionally, if at 320 the memory system 210 determines to activate the second firmware slot 225-b, the memory system 210 may proceed to 335.

At 325, the memory system 210 may operate the memory system 210 in the operational mode. In particular, the memory system 210 may activate the first firmware slot 225-a and deactivate the second firmware slot 225-b (e.g., based on only activating a single firmware slot 225 at one time). Then, the memory system 210 may load the operational firmware image stored in the first firmware slot 225-a and initialize the memory system 210 in accordance with the operational firmware. The controller 215 may then execute the operational firmware indicated by the operational firmware image. By executing the operational firmware, the controller 215 may operate the memory system 210 in the operational or core functionality mode of operation. In particular, the memory system 210 may communicate with the host system 205 via the interface 220 based on operating in the operational mode of operation.

In some cases, the memory system 210 may be capable of temporarily or permanently deactivating the second firmware slot 225-b. Here, the memory system 210 may be operating in the core or operational mode using the operational firmware. The memory system 210 being capable of temporarily or permanently deactivating the second firmware slot 225-b may improve a security of the memory system 210. For example, updates to the diagnostic firmware image stored in the second firmware slot 225-b may be subject to less stringent testing and/or validation. Accordingly, if the diagnostic firmware negatively impacts an operation of the memory system 210 (e.g., due to an unforeseen negative consequence of a diagnostic firmware update), the memory system 210 temporarily or permanently deactivating the second firmware slot 225-b may improve the reliability of the memory system 210.

At 330, the memory system 210 may optionally determine to switch from the operational mode to the diagnostic mode. In one case, the memory system 210 may receive a command from the host system 205 indicating for the memory system 210 to activate the second firmware slot 225-b. In another case, the memory system 210 may determine to switch into the diagnostic mode in response to detecting a trigger condition associated with the memory system 210 switching to the diagnostic mode. For example, the memory system 210 may switch to the diagnostic mode in response to detecting a quantity of errors within data stored in a memory array 230 that exceeds a threshold. In another example, a built-in monitoring system (e.g., a S.M.A.R.T. monitoring system) may trigger the switch to the diagnostic mode in response to detecting conditions that indicate a potential failure of the memory system 210 or a degraded performance of the memory system 210. In another case, the memory system 210 may determine to switch into the diagnostic mode in accordance with a periodically scheduled switch to the diagnostic mode. For example, the memory system 210 may be configured to perform self-testing according to a certain periodicity. Accordingly, the memory system 210 may switch to the diagnostic mode based on the periodicity.

At 335, the memory system 210 may operate the memory system 210 in the diagnostic mode. In particular, the memory system 210 may activate the second firmware slot 225-b and deactivate the first firmware slot 225-a (e.g., based on only activating a single firmware slot 225 at one time). Then, the memory system 210 may load the diagnostic firmware image stored in the second firmware slot 225-b and initialize the memory system 210 in accordance with the diagnostic firmware. The controller 215 may then execute the diagnostic firmware indicated by the diagnostic firmware image. By executing the diagnostic firmware, the controller 215 may operate the memory system 210 in the diagnostic or offline mode of operation.

In one example, the memory system 210 may perform a S.M.A.R.T. self-test while operating in the diagnostic mode. As part of the S.M.A.R.T self-test, the memory system 210 may perform a check of the RAM at the memory system 210. For example, the memory system 210 may write data to the RAM and verify that the data is not corrupted by the RAM (e.g., the memory system 210 may write pattern data such as 0x5A5A5A5A, 0xFFFFFFFF, and 0x55AA55AA, and verify whether the RAM is operating correctly based on whether data read from the RAM matches the pattern data). Additionally, as part of the S.M.A.R.T. self-test, the memory system 210 may read a S.M.A.R.T. critical warning field to determine whether any volatile memory backup devices have failed. Additionally, the memory system 210 may test a backup functionality of the volatile memory of the memory system 210, validate a flash translation layer metadata of the memory system 210 (which may enable the memory system 210 to map between the logical block addresses and physical locations on a NAND flash of the memory system 210), and test an integrity of the nonvolatile memory of the memory system 210. Additionally, or alternatively, the memory system 210 may check a data integrity of data stored at the memory system 210, verify an error correction code status of data stored in NAND at the memory system, or monitor an overall lifespan and health of the memory system 210.

At 340, the memory system 210 may optionally determine to switch from the diagnostic mode to the operational mode. In one case, the memory system 210 may receive a command from the host system 205 indicating for the memory system 210 to activate the first firmware slot 225-a. In another case, the memory system 210 may determine to switch into the diagnostic mode in response to completing one or more diagnostic or offline operations while operating the memory system 210 in the diagnostic mode. Additionally, or alternatively, the memory system 210 may switch to the operational mode in accordance with a periodically scheduled switch to the operational mode. For example, the memory system 210 may be configured to perform self-testing according to a certain periodicity. Accordingly, the memory system 210 may switch back to the operational mode based on the periodicity.

As indicated above, FIG. 3 is provided as an example. Other examples may differ from what is described with regard to FIG. 3.

FIG. 4 is a diagram of an example 400 of a process performed by a memory system that supports a split firmware architecture. The operations described in connection with FIG. 4 may be performed by the memory system 210, and/or one the controller 215 or the memory system 210. The example 400 relates to a process of the memory system 210 updating the firmware image stored in one firmware slot 225 without impacting a functionality of the firmware image stored in another firmware slot 225.

At 405, the memory system 210 may receive a firmware update command. For example, the host system 205 may transmit the firmware update command, and the firmware update command may include an updated firmware image for the memory system 210. For example, the firmware update command may include an updated diagnostic firmware image or an updated operational firmware image.

At 410, the memory system 210 may identify the firmware slot 225 for the firmware update. That is, the firmware update command may include an indication of a firmware slot 225 at the memory system 210. For example, if the firmware update command is for a diagnostic firmware update, the firmware update command may include an indication of the second firmware slot 225-b.

At 415, the memory system 210 may store the updated firmware image in the identified firmware slot 225. For example, if the firmware update command includes an updated diagnostic firmware image and indicates the second firmware slot 225-b, the memory system 210 may store the updated diagnostic firmware image in the second firmware slot 225-b. Because the firmware of the memory system 210 is divided into distinct subsets and stored separately (e.g., within different firmware slots 225), storing an updated firmware image in one firmware slot 225 does not impact the functionality of the other firmware image. For example, storing the updated diagnostic firmware image in the second firmware slot 225-b does not impact the core functionality of the memory system 210 that is controlled by the operational firmware image stored in the first firmware slot 225-a. Therefore, the memory system 210 may perform firmware updates on the diagnostic or offline firmware image without compromising the core functionality of the memory system 210.

At 420, the memory system 210 may activate the identified firmware slot 225 (e.g., to execute the updated firmware). In some cases, the host system 205 may indicate for the memory system 210 to perform a warm start of the memory system 210 (e.g., of the mNVM that corresponds to the memory system 210) and may specify for the memory system 210 to use the identified firmware slot 225 for the warm start. To perform the warm start, the memory system 210 may restart the memory system 210 without completely powering it down, which may enable the memory system 210 to begin operating faster as compared to a cold start (e.g., where the memory system 210 completely powers down). During the warm start, the memory system 210 may reinitialize and reload the updated firmware and other essential components, but the memory system 210 may retain certain states and data in volatile memory.

As indicated above, FIG. 4 is provided as an example. Other examples may differ from what is described with regard to FIG. 4.

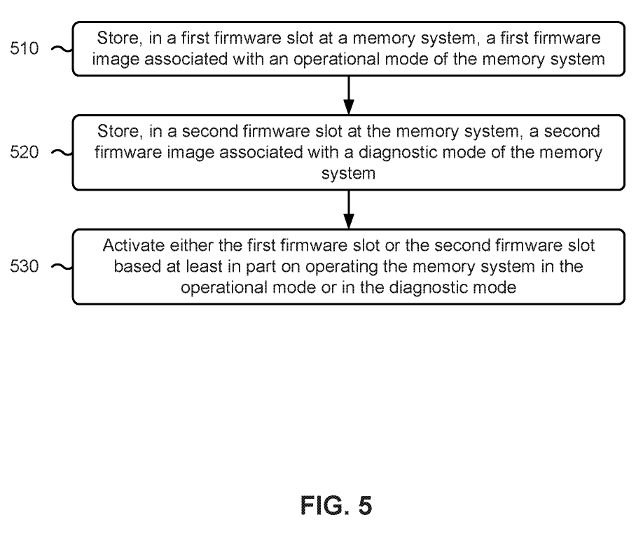

FIG. 5 is a flowchart of an example method 500 associated with a memory system that includes a split firmware architecture. In some implementations, a memory system (e.g., the memory system 110, the memory system 210) may perform or may be configured to perform the method 500. Additionally, or alternatively, one or more components of the memory system (e.g., the memory system controller 115, the controller 215) may perform or may be configured to perform the method 500. Thus, means for performing the method 500 may include the memory system and/or one or more components of the memory system. Additionally, or alternatively, a non-transitory computer-readable medium may store one or more instructions that, when executed by the memory system, cause the memory system to perform the method 500.

As shown in FIG. 5, the method 500 may include storing, in a first firmware slot at a memory system, a first firmware image associated with an operational mode of the memory system (block 510). As further shown in FIG. 5, the method 500 may include storing, in a second firmware slot at the memory system, a second firmware image associated with a diagnostic mode of the memory system (block 520). As further shown in FIG. 5, the method 500 may include activating either the first firmware slot or the second firmware slot based at least in part on operating the memory system in the operational mode or in the diagnostic mode (block 530).

The method 500 may include additional aspects, such as any single aspect or any combination of aspects described below and/or described in connection with one or more other methods or operations described elsewhere herein.

In a first aspect, the method 500 includes receiving, from a host system, a command indicating for the memory system to activate either the first firmware slot or the second firmware slot, wherein the activating is based at least in part on whether the command indicates for the memory system to activate the first firmware slot or the second firmware slot.

In a second aspect, alone or in combination with the first aspect, the method 500 includes storing an updated version of the second firmware image in the second firmware slot, wherein the updated version of the second firmware image changes an operation of the memory system in the diagnostic mode without changing the operation of the memory system in the operational mode.

In a third aspect, alone or in combination with one or more of the first and second aspects, the method 500 includes receiving, from a host system, a firmware update command comprising an indication of the second firmware slot and the updated version of the second firmware image, wherein storing the updated version of the second firmware image in the second firmware slot is based at least in part on receiving the firmware update command.

In a fourth aspect, alone or in combination with one or more of the first through third aspects, the activating comprises activating the first firmware slot based at least in part on operating the memory system in the operational mode, and the method 500 includes deactivating the second firmware slot prior to activating the first firmware slot.

In a fifth aspect, alone or in combination with one or more of the first through fourth aspects, the method 500 includes operating the memory system in the operational mode based at least in part on activating the first firmware slot and deactivating the second firmware slot.

In a sixth aspect, alone or in combination with one or more of the first through fifth aspects, operating the memory system in the operational mode comprises executing one or more operations indicated to the memory system by a host system.

In a seventh aspect, alone or in combination with one or more of the first through sixth aspects, the method 500 includes deactivating the first firmware slot and activating the second firmware slot based at least in part on determining to switch the memory system from the operational mode to the diagnostic mode.

In an eighth aspect, alone or in combination with one or more of the first through seventh aspects, the activating comprises activating the second firmware slot based at least in part on operating the memory system in the diagnostic mode, and the method 500 includes deactivating the first firmware slot prior to activating the second firmware slot.

In a ninth aspect, alone or in combination with one or more of the first through eighth aspects, the method 500 includes operating the memory system in the diagnostic mode based at least in part on activating the second firmware slot and deactivating the first firmware slot.

In a tenth aspect, alone or in combination with one or more of the first through ninth aspects, operating the memory system in the diagnostic mode comprises performing one or more diagnostic operations at the memory system, and refraining from executing operations indicated to the memory system.

In an eleventh aspect, alone or in combination with one or more of the first through tenth aspects, the method 500 includes deactivating the second firmware slot and activating the first firmware slot based at least in part on determining to switch the memory system from the diagnostic mode to the operational mode.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory system includes a memory array comprising: a first firmware slot configured to store a first firmware image associated with a first disjoint subset of a firmware for the memory system, and a second firmware slot configured to store a second firmware image associated with a second disjoint subset of the firmware for the memory system; and a controller coupled to the memory array, the controller configured to: operate the memory system according to the first disjoint subset of the firmware based at least in part on activating the first firmware slot and deactivating the second firmware slot, or operate the memory system according to the second disjoint subset of the firmware based at least in part on deactivating the first firmware slot and activating the second firmware slot.

In some implementations, a method includes storing, in a first firmware slot at a memory system, a first firmware image associated with an operational mode of the memory system; storing, in a second firmware slot at the memory system, a second firmware image associated with a diagnostic mode of the memory system; and activating either the first firmware slot or the second firmware slot based at least in part on operating the memory system in the operational mode or in the diagnostic mode.

In some implementations, an apparatus includes means for storing, in a first firmware slot at the apparatus, a first firmware image associated with an operational mode of the apparatus; means for storing, in a second firmware slot at the apparatus, a second firmware image associated with a diagnostic mode of the apparatus; and means for activating either the first firmware slot or the second firmware slot based at least in part on operating the apparatus in the operational mode or in the diagnostic mode.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
a memory array comprising:
a first firmware slot configured to store a first firmware image associated with a first disjoint subset of a firmware for the memory system, and
a second firmware slot configured to store a second firmware image associated with a second disjoint subset of the firmware for the memory system; and
a controller coupled to the memory array, the controller configured to:
operate the memory system according to the first disjoint subset of the firmware based at least in part on activating the first firmware slot and deactivating the second firmware slot, or
operate the memory system according to the second disjoint subset of the firmware based at least in part on deactivating the first firmware slot and activating the second firmware slot.

2. The memory system of claim 1, wherein:
the first disjoint subset of the firmware is associated with a first functionality of the memory system; and
the second disjoint subset of the firmware is associated with a second functionality of the memory system that is different from the first functionality.

3. The memory system of claim 2, wherein:
the first functionality corresponds to a core functionality of the memory system; and
the second functionality corresponds to a self-test functionality of the memory system.

4. The memory system of claim 3, wherein:
operating the memory system according to the first disjoint subset of the firmware comprises performing one or more operations associated with the core functionality of the memory system; and
operating the memory system according to the second disjoint subset of the firmware comprises performing one or more operations associated with the self-test functionality of the memory system.

5. The memory system of claim 1, wherein the controller is further configured to:
update the second disjoint subset of the firmware without changing the first disjoint subset of the firmware.

6. The memory system of claim 5, further comprising an interface coupled to the controller, the interface configured to:
receive, from a host system, a firmware update for the second disjoint subset of the firmware, wherein the controller is configured to update the second disjoint subset of the firmware responsive to receiving the firmware update.

7. The memory system of claim 5, wherein the controller is further configured to:
deactivate the first firmware slot prior to updating the second disjoint subset of the firmware, wherein updating the second disjoint subset of the firmware without changing the first disjoint subset of the firmware is based at least in part on deactivating the first firmware slot prior to the updating.

8. The memory system of claim 1, wherein:
the first firmware slot corresponds to a first partition of the memory array; and
the second firmware slot corresponds to a second partition of the memory array that is disjoint from the first partition.

9. A method, comprising:
storing, in a first firmware slot at a memory system, a first firmware image associated with an operational mode of the memory system;
storing, in a second firmware slot at the memory system, a second firmware image associated with a diagnostic mode of the memory system; and
activating either the first firmware slot or the second firmware slot based at least in part on operating the memory system in the operational mode or in the diagnostic mode.

10. The method of claim 9, further comprising:
receiving, from a host system, a command indicating for the memory system to activate either the first firmware slot or the second firmware slot, wherein the activating is based at least in part on whether the command indicates for the memory system to activate the first firmware slot or the second firmware slot.

11. The method of claim 9, further comprising:
storing an updated version of the second firmware image in the second firmware slot, wherein the updated version of the second firmware image changes an operation of the memory system in the diagnostic mode without changing the operation of the memory system in the operational mode.

12. The method of claim 11, further comprising:
receiving, from a host system, a firmware update command comprising an indication of the second firmware slot and the updated version of the second firmware image, wherein storing the updated version of the second firmware image in the second firmware slot is based at least in part on receiving the firmware update command.

13. The method of claim 9, wherein:
the activating comprises activating the first firmware slot based at least in part on operating the memory system in the operational mode; and
the method further comprises deactivating the second firmware slot prior to activating the first firmware slot.

14. The method of claim 13, further comprising:
operating the memory system in the operational mode based at least in part on activating the first firmware slot and deactivating the second firmware slot.

15. The method of claim 14, wherein operating the memory system in the operational mode comprises:
executing one or more operations indicated to the memory system by a host system.

16. The method of claim 13 further comprising:
deactivating the first firmware slot and activating the second firmware slot based at least in part on determining to switch the memory system from the operational mode to the diagnostic mode.

17. The method of claim 9, wherein:
the activating comprises activating the second firmware slot based at least in part on operating the memory system in the diagnostic mode; and
the method further comprises deactivating the first firmware slot prior to activating the second firmware slot.

18. The method of claim 17, further comprising:
operating the memory system in the diagnostic mode based at least in part on activating the second firmware slot and deactivating the first firmware slot.

19. The method of claim 18, wherein operating the memory system in the diagnostic mode comprises:
performing one or more diagnostic operations at the memory system; and
refraining from executing operations indicated to the memory system.

20. The method of claim 17, further comprising:
deactivating the second firmware slot and activating the first firmware slot based at least in part on determining to switch the memory system from the diagnostic mode to the operational mode.

21. An apparatus, comprising:
means for storing, in a first firmware slot at the apparatus, a first firmware image associated with an operational mode of the apparatus;
means for storing, in a second firmware slot at the apparatus, a second firmware image associated with a diagnostic mode of the apparatus; and
means for activating either the first firmware slot or the second firmware slot based at least in part on operating the apparatus in the operational mode or in the diagnostic mode.

22. The apparatus of claim 21, further comprising:
means for receiving, from a host system, a command indicating for the apparatus to activate either the first firmware slot or the second firmware slot, wherein the activating is based at least in part on whether the command indicates for the apparatus to activate the first firmware slot or the second firmware slot.

23. The apparatus of claim 21, further comprising:
means for receiving, from a host system, a firmware update command comprising an indication of the second firmware slot and an updated version of the second firmware image; and
means for storing the updated version of the second firmware image in the second firmware slot based at least in part on receiving the firmware update command, wherein the updated version of the second firmware image changes an operation of the apparatus in the diagnostic mode without changing the operation of the apparatus in the operational mode.

24. The apparatus of claim 21, wherein:
the means for activating comprises means for activating the first firmware slot based at least in part on operating the apparatus in the operational mode; and
the apparatus further comprises means for deactivating the second firmware slot prior to activating the first firmware slot.

25. The apparatus of claim 21, wherein:
the means for activating comprises means for activating the second firmware slot based at least in part on operating the apparatus in the diagnostic mode; and
the apparatus further comprises means for deactivating the first firmware slot prior to activating the second firmware slot.
